(19) United States
(12) Patent Application Publication
(10) Pub. No.: US 2019/0244167 A1
(43) Pub. Date: Aug. 8, 2019

(54) INFORMATION PROCESSING APPARATUS, PICK-UP AND DELIVERY SYSTEM, PICK-UP AND DELIVERY METHOD, AND NON-TRANSITORY COMPUTER READABLE RECORDING MEDIUM

(71) Applicant: Toyota Jidosha Kabushiki Kaisha, Nagoya-shi Aichi-ken (JP)

(72) Inventors: Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/266,375

(22) Filed: Feb. 4, 2019

(30) Foreign Application Priority Data
Feb. 6, 2018 (JP) 2018-018795

(51) Int. Cl. G06Q 10/08; G05D 1/02

(52) U.S. Cl. CPC G06Q 10/0832; G05D 1/0212; G06Q 10/0833

(57) ABSTRACT

An information processing apparatus includes a receiving unit and a managing unit. The receiving unit receives a delivery request including a pick-up paint and a drop-off point for a package. The managing unit selects one of a first delivery procedure for transporting the package from the pick-up point to the drop-off point by using a single mobile object and a second delivery procedure for transporting the package from the pick-up point to the drop-off point by transshipping the package between a plurality of mobile objects, and instructs a control unit configured to control transportation via the mobile object such that the package is delivered in accordance with the selected delivery procedure.

### CROSS-REFERENCE TO RELATED APPLICATIONS

This application claims priority to Japanese Patent Application No. 2018-018795 filed on Feb. 6, 2018, which is incorporated herein by reference in its entirety including the specification, drawings, and abstract.

### BACKGROUND

### 1. Technical Field

The present disclosure relates to an information processing apparatus, a pick-up and delivery system, a pick-up and delivery method, and a non-transitory computer readable recording medium for picking up a package and delivering the picked-up package by, using a mobile object.

2. Description of Related Art

Studies have been conducted on providing services using autonomous mobile objects. For example, Japanese Patent No. 6164599 (JP 6164599 B) discloses a delivery system including autonomous mobile objects which deliver packages to a place where a delivery locker unit is installed, thereby improving delivery efficiency.

### SUMMARY

The related art is intended to improve efficiency by using a receiving unit such as a delivery locker, but does not take into account reducing a transit time from the viewpoint of the entire system configured to pick up and deliver packages.

The present disclosure relates to a system configured to pick up and deliver packages depending on delivery distances or a user's circumstances,

A first aspect of the present disclosure is exemplified by an information processing apparatus as described below. The information processing apparatus includes: a receiving unit configured to receive a delivery request including a pick-up point and a drop-off point for a package; and a managing unit configured to select one of a first delivery procedure for transporting the package with a single mobile object from the pick-up point to the drop-off point and a second delivery procedure for transporting the package from the pick-up point to the drop-off point by transshipping the package between a plurality of mobile objects, and to provide a control unit configured to control to control transportation via the mobile object with instruction on the delivery of the package in accordance with the selected delivery procedure.

As the information processing apparatus selects one of the first delivery procedure and the second delivery procedure, the information processing apparatus may provide the control unit with instruction to deliver the packages in accordance with an appropriate delivery procedure depending on various purposes and circumstances such as delivery efficiency and a user's circumstances.

The managing unit may be configured to select one of the first delivery procedure and the second delivery procedure depending on whether the pick-up point and the drop-off point satisfy a predetermined condition. As the relationship between the pick-up point and the drop-off point has an effect on delivery efficiency or delivery status, the managing unit may provide the control unit with instruction to deliver the packages in accordance with a more appropriate delivery procedure by determining whether the pick-up point and the drop-off point satisfy the predetermined condition.

The predetermined condition may be whether information on an area which is included in an address of the pick-up point overlaps with information on an area which is included in an address of the drop-off point, or whether the pick-up point and the drop-off point are located within a predetermined distance. When the areas including the points overlap with each other, for example when the areas specified by the addresses of the pick-up point and the drop-off point overlap with each other, it will be advantageous for packages to be transported from the pick-up point to the drop-off point by a single mobile object in terms of delivery efficiency. Also, when the pick-up point and the drop-off point are located within the predetermined distance, it will be also advantageous for the packages to be transported by a single mobile object from the pick-up point to the drop-off point in terms of delivery efficiency. Accordingly, as the managing unit determines such conditions, it may provide the control unit with instruction to deliver the packages in accordance with a more appropriate delivery procedure.

Alternatively, the managing unit may receive a user's selection for the delivery procedure from a user at a delivery request point and select the first delivery procedure or the second delivery procedure by prioritizing the user's selection. By doing so, the information processing apparatus can provide the user with a desirable service and can increase added value of the delivery service.

A second aspect of the present disclosure relates to a pick-up and delivery system including an information processing apparatus as described above and a mobile object. A third aspect of the present disclosure relates to a method executed by the information processing apparatus that is a computer. A fourth aspect of the present disclosure relates to a non-transitory computer readable recording medium with a program recorded thereon in which the program includes commands for causing a computer to execute the processing by the information processing apparatus.

With each aspect of the present disclosure, the delivery time can be shortened depending on the delivery distances or the user's circumstances,

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 illustrates an operational example of a pick-up and delivery system in accordance with one embodiment;

FIG. 2 is a block diagram schematically showing an example of each component of a pick-up and delivery system;

FIG. 3 illustrates an example of the exterior of an autonomous vehicle 100;

FIG. 4 illustrates an example of a configuration of a delivery management table;

FIG. 5 illustrates an example of a configuration of operation commands that are generated based on delivery management information;

FIG. 6 illustrates an example of a configuration of a user management table;

FIG. 7 illustrates an example of a configuration of a fee table for direct delivery;

FIG. 8 illustrates another example of a configuration of a fee table for direct delivery;

FIG. 9 illustrates an example of a hardware configuration of a server device;

FIG. 10 is a flow diagram of data transmitted and received between the components of the system;

FIG. 11 is a flowchart of processes executed by an autonomous vehicle;

FIG. 12 is a flowchart showing an example of a process of generating delivery management information;

FIG. 13 is a flowchart showing a detailed example of a delivery procedure determining process; and

FIG. 14 is a flowchart showing an example of modification of details of a delivery procedure determining process.

### DETAILED DESCRIPTION OF EMBODIMENTS

### Operational Example of System

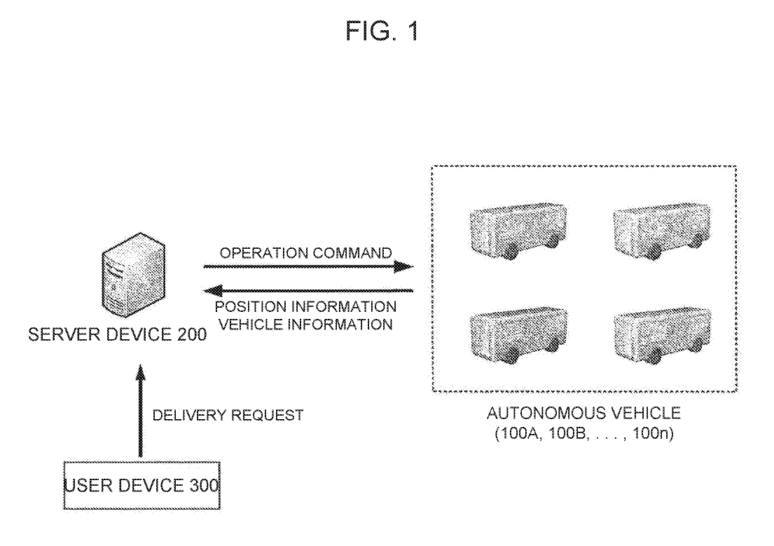

Hereinafter, a server device 200 which is an information processing apparatus, a pick-up and delivery system, a pick-up and delivery method, and a recording medium with a program recorded thereon will be described in accordance with one embodiment with reference to the drawings. An operational example of the pick-up and delivery system according to the present embodiment will be described with reference to FIG. 1. The pick-up and delivery system according to the present embodiment includes a server device 200 that issues a command based on a delivery request from a user, and a plurality of autonomous vehicles 100A, . . . , 100n that performs autonomous driving based on a given command. FIG. 1 also illustrates a user device 300 that transmits a delivery request from a user. A user who transmits a delivery request may also be referred to as a user as a delivery requestor (hereinafter referred to as a “user”). Although it is not illustrated in FIG. 1, it is assumed that a user as a recipient of a package also has a device such as the user device 300. The user as a recipient of a package is hereinafter referred to as a recipient user. A delivery request is an example of a request for delivery.

The autonomous vehicle 100 is an autonomous driving vehicle that provides transportation services, and the server device 200 is a device that manages a plurality of autonomous vehicles 100. Hereinafter, when the autonomous vehicles are referred to collectively, not individually, the autonomous vehicles are simply referred to as the autonomous vehicle 100. The autonomous vehicle 100 is an example of a mobile object.

The autonomous vehicle 100 is an autonomous driving vehicle capable of traveling with a package loaded thereon. The autonomous vehicle 100 is also referred to as an electric vehicle (EV) palette. In addition, the autonomous vehicle 100 does not need to be an unmanned vehicle. For example, a sales person, a customer service agent, or a security guard may board the autonomous vehicle 100. Furthermore, the autonomous vehicle 100 does not necessarily need to be a vehicle capable of completely autonomous driving. For example, the autonomous vehicle 100 may be driven or assisted in driving by a person depending on the situation. In the present embodiment, the autonomous vehicle 100 can travel to a designated drop-off point to deliver a package or to a designated pick-up point to pick up a package.

Further, the autonomous vehicle 100 may have a function of receiving a request from the user, responding to the user, executing a predetermined process in response to the request from the user, and reporting a processing result to the user. In addition, the autonomous vehicle 100 may transmit, to the server device 200, a request which cannot be processed by the autonomous vehicle 100 alone among the requests from the user, and process the corresponding request in conjunction with the server device 200.

The user device 300 receives a delivery request from the user and transmits the delivery request to the server device 200. In the present embodiment, picking up a package from a user to the autonomous vehicle 100 is referred to as “pick-up,” and delivering a package from a pick-up point to a drop-off point is referred to as “delivery,” However, it may be implicitly assumed that a delivery request input from the user device 300 to the server device 200 includes a request for pick-up.

The server device 200 instructs the autonomous vehicle 100 to operate. The server device 200 generates an operation command based on a delivery request transmitted from the user device 300. The server device 200 generates the operation command to deliver package “from a collection and delivery base to a drop-off point,” “from a pick-up point to a collection and delivery base” or “from a pick-up point directly to a drop-off point without passing through a collection and delivery base,” for example, based on information on a package to be loaded onto the autonomous vehicle 100 (for example, information on a designated drop-off point or a designated time), and information on the package to be picked up (for example, information on a designated pick-up point or a designated time). As a result, the autonomous vehicle 100 can pick up, and deliver a package via the collection and delivery base, or deliver a package from a pick-up point to a drop-off point without passing through the collection and delivery base (hereinafter referred to as “direct delivery”). Further, the operation command is not only for traveling. The operation command may include, for example, commands to “unload (hand over) a package at a designated place” and “issue a receipt.” As such, the operation command may include actions to be taken by the autonomous vehicle 100 other than traveling. Also, the autonomous vehicle 100 may be provided with components for the actions.

### System Configuration

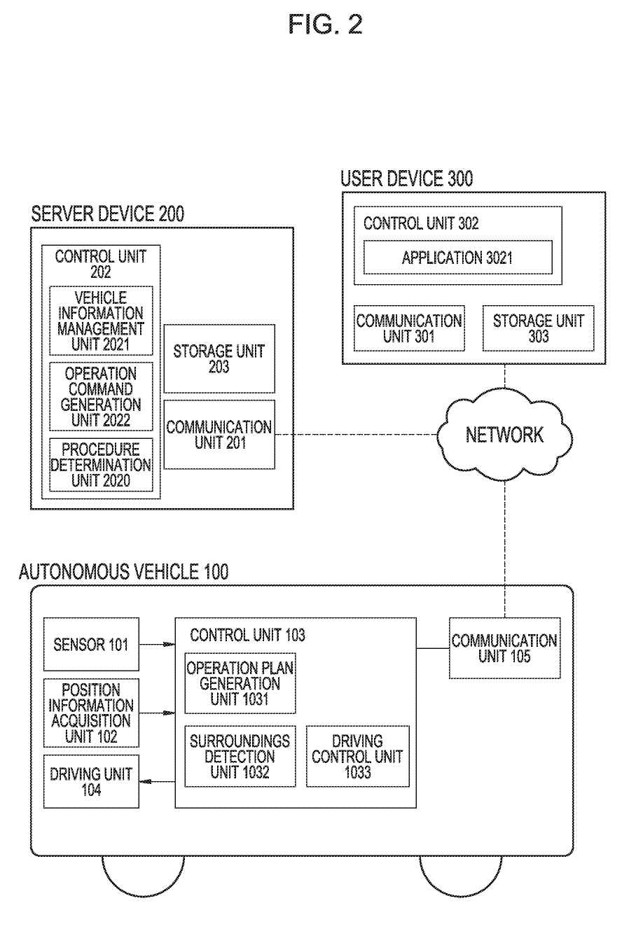

The components of the system will be described in detail. FIG. 2 is a block diagram schematically illustrating art example of a configuration of a pick-up and delivery system including the autonomous vehicle 100 and the server device 200 as illustrated in FIG. 1. In addition, FIG. 1 illustrates the user device 300.

The autonomous vehicle 100 travels according to an operation command acquired from the server device 200. in particular, the autonomous vehicle 100 generates a travel route based on the operation command acquired through wireless communication, and travels on a road in an appropriate manner while sensing the surroundings of the vehicle.

The autonomous vehicle 100 includes a sensor 101, a position information acquisition unit 102, a control unit 103, a driving unit 104, and a communication unit 105. The autonomous vehicle 100 is operated by power supplied from a battery which is not illustrated.

The sensor 101 senses the surroundings of the vehicle, and typically includes a stereo camera, a laser scanner, light detection and ranging (LIDAR), laser imaging detection, and ranging (LADAR), radar, and the like. The information acquired by the sensor 101 is transmitted to the control unit 103. The sensor 101 may include a sensor configured to support autonomous driving of the vehicle. The sensor 101 may include a camera mounted on the vehicle body of the autonomous vehicle 100. For example, the sensor 101 may include an imaging device using an image sensor such as a charge-coupled device (LCD), a metal-oxide-semiconductor (MOS), or a complementary metal-oxide-semiconductor (CMOS). A plurality of cameras may be installed at a plurality of places on the vehicle body, For example, cameras may be respectively installed at the front, rear, right, and left sides of the vehicle body.

The position information acquisition unit 102 acquires the current location of the vehicle, and typically includes a Global Positioning System (GPS) receiver and the like. The information acquired by the position information acquisition unit 102 is transmitted to the control unit 103.

The control unit 103 is a computer which controls the autonomous vehicle 100 based on information acquired from the sensor 101, the position information acquisition unit 102, and the like. The control unit 103 is, for example, a microcomputer. The control unit 103 is an example of a control unit configured to control transportation via a mobile object because the control unit 103 controls transportation in response to the operation command from the server device 200.

The control unit 103 includes an operation plan generation unit 1031, an surroundings detection unit 1032, and a task control unit 1033, as functional modules. Each functional module may be implemented by executing a program stored in a storage unit, such as read only memory (ROM), via a central processing unit (CPU) (neither shown). However, each functional module of the control unit 103 may include hardware circuitry, such as digital circuitry, or a dedicated processor such as a digital signal processor (DSP).

The operation plan generation unit 1031 acquires an operation command from the server device 200 and generates an operation plan of the subject vehicle. in the present embodiment, the operation plan is data defining a route along which the autonomous vehicle 100 travels and a process to be performed by the autonomous vehicle 100 in a part of or the whole of the route. Examples of the data included in the operation plan will be described below.

(1) Data Representing Route along Which Vehicle Travels as Set of Road Links

A route along which the vehicle travels may be automatically generated based on a given departure point and a given destination, for example, with reference to Map data stored in a storage unit which is not shown, in addition, the route may be generated by using an external service.

(2) Data Representing Process to be performed by Vehicle at Point on Route

Processes to be performed by the vehicle on a route include, but is not limited to, for example, “handing over a designated package to the user,” “receiving a package from the user,” and “receiving a receipt or a claim check.” The operation plan generated by the operation plan generation unit 1031 is transmitted to the task control unit 1033 that will be described hereinbelow.

The surroundings detection unit 1032 detects the surroundings of a vehicle based on the data acquired by the sensor 101. Objects to be detected include, but are not limited to, for example, the number or positions of lanes, the number or positions of other vehicles around the vehicle, the number or positions of obstacles around the vehicle (for example, pedestrians, bicycles, structures, or buildings), the structure of roads, or road signs. The objects to be detected may be whatever is necessary for autonomous driving. Furthermore, the surroundings detection unit 1032 may track a detected object, For example, the surroundings detection unit 1032 may obtain a relative speed of an object from a difference between the coordinates of the object detected one step before and the current coordinates of the object. The data on surroundings (hereinafter referred to as “the surroundings data”) detected by the surroundings detection, unit 1032 is transmitted to the task control unit 1033 that will be described hereinbelow.

The task control unit 1033 controls the travel of the vehicle based on the operation plan generated by the operation plan generation unit 1031, the surroundings data generated by the surroundings detection unit 1032, and vehicle position information acquired by the position information acquisition unit 102. For example, under the control of the task control unit 1033. a vehicle travels along a designated route such that obstacles do not enter a predetermined safety area around the vehicle, A well-known method may be employed as a method for performing autonomous driving of a vehicle. Further, the task control unit 1033 may control tasks other than traveling (for example, receiving, a package from the user and issuing a receipt or a claim check), based on the operation plan generated by the operation plan generation unit 1031 (if necessary, based on the surroundings data generated by the surroundings detection unit 1032 and the vehicle position information acquired by the position information acquisition unit 102, and the like).

The driving unit 104 drives the autonomous vehicle 100 based on the command generated by the task control unit 1033. The driving unit 104 includes, for example, a motor for rotating the wheel, an inverter, a brake, a steering mechanism, and a secondary battery.

The communication unit 105 is configured to connect the autonomous vehicle 100 to a network. In the present embodiment, the communication unit 105 may communicate with other devices (for example, the server device 200), through a network by using a mobile communication service, such as a 3rd generation (3G) or a Long Term Evolution (LTE). In addition, the communication unit 105 may further include, communication units configured to perform vehicle-to-vehicle communication with another autonomous vehicle 100.

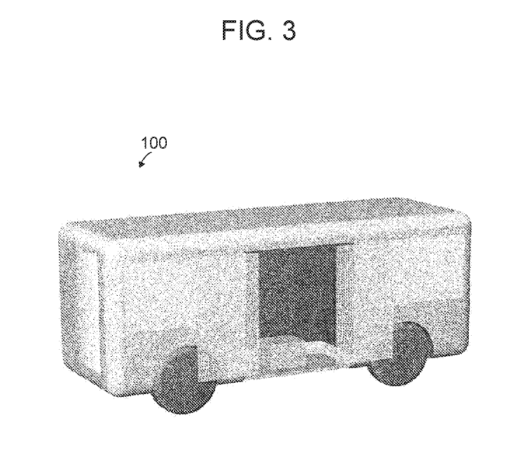

The autonomous vehicle 100 includes a mechanism configured to load a package. As shown in FIG. 3, the autonomous vehicle 100 is configured such that a package is loaded on its vehicle cabin, Although only one package is illustrated in the example shown in FIG. 3, the autonomous vehicle 100 is configured to be capable of being loaded with a plurality of packages. Further, the autonomous vehicle 100 may include a mechanism configured to hand over only a designated package among a plurality of packages, For example, a storage apparatus having a plurality of storage compartments (also referred to as “blocks”) may be provided in the vehicle cabin and only permitted blocks may be unlocked. Further, the autonomous vehicle 100 may include a mechanism configured to hand over the loaded package to another device. The autonomous vehicle 100 may include a mechanism configured to be connected to an external storage apparatus, such as a delivery locker, to transfer the package. In addition, the autonomous vehicle 100 may include a mechanism configured to receive and hand over packages from, and to an autonomous mobile object (for example, a personal assistant robot), managed by the user. Further, the autonomous vehicle 100 may be provided with a mechanism configured to issue a receipt or a claim check. The above-described mechanisms and devices are controlled by the task control unit 1033.

Next, the server device 200 will be described. The server device 200 manages the positions and status of the autonomous vehicles 100, and generates and transmits an operation command. For example, when, receiving a pick-up request from the user device 300, the server device 200 acquires a place to pick up a package, and then transmits an operation command to an autonomous vehicle 100 that is traveling near the place and is available for pickup of the package.

The server device 200 includes a communication unit 201, a control unit 202, and a storage unit 203. The communication unit 201, like the communication unit 105, is a communication interface configured to perform communication with the autonomous vehicle 100 via a network.

The control unit 202 controls the server device 200. The control unit 202 includes, for example, a central processing unit (CPU). The control unit 202 includes, as functional modules, a vehicle information management unit 2021, an operation command generation unit 2022, and a procedure determination unit 2020. Each functional module may be implemented by executing a program stored in a storage unit, such as ROM, via a CPU (neither shown). However, each functional module of the control unit 202 may include hardware circuitry, such as digital circuitry, or a dedicated processor, such as a DSP.

The vehicle information management unit 2021 manages the plurality of autonomous vehicles 100, In detail, the vehicle information management unit 2021 receives data on the autonomous vehicle 100 (information on a mobile object) at predetermined intervals, from the autonomous vehicles 100, and stores the data in the storage unit 203 that will be described hereinbelow. In the present embodiment, the vehicle information management unit 2021 uses position information and vehicle information as the data on the autonomous vehicle 100. The vehicle information includes, but is not limited to, for example, an identifier of the autonomous vehicle 100, usage and vehicle type, information on a holding area (a garage or a sales office), a door type, a vehicle body size, a trunk size, a loading capacity, a travelable distance when fully charged, a travelable distance at a current time point, and a current status (for example, an amount, weight, and, volume of currently loaded packages, an amount, weight, and volume of packages to be picked up, and a pick-up point).

The procedure determination unit 2020 receives a delivery request from the user device 300, generates delivery management information, and stores the information in a delivery management table. The procedure determination unit 2020 receives the delivery request from, for example, a graphical user interface (GUI) of a website or a GUI of an application program downloaded to the user device 300 of the user. By setting predetermined information in the GUI, the user transmits the delivery request to the procedure determination unit 2020. The delivery request includes, but is not limited to, for example, the following requests.

(1) Via-Center Delivery Request

The via-center delivery request is a request to deliver a package to a drop-off point via one or more collection and delivery bases. The via-center delivery request may include the number, size, and weight of the package, information on the pick-up point, information on the drop-off point. and the like. In the present embodiment, when the user designates “via-center delivery request” on the GUI of the user device 300, the via-center delivery request is transmitted from the user device 300 to the server device 200.

(2) Direct Delivery Request

The direct delivery request is a request to pick up a package from the user and deliver the package directly to a drop-off point without passing through a collection and delivery base. The direct delivery request may include the number, size, and weight of the package, information on the pick-up point, information on the drop-off point, and the like. In the present embodiment, when the user designates “direct delivery” on the GUI of the user device 300, the direct delivery request is transmitted from the user device 300 to the server device 200.

(3) Delivery Request without Designation of Delivery Procedure

The delivery request without designation of a delivery procedure is a delivery request that is not designated as “via-center delivery request” or “direct delivery.” For the delivery request without designation of a delivery procedure, the procedure determination unit 2020 of the server device 200 determines whether the delivery request is a via-center delivery request or a direct delivery request.

(4) Pick-Up Request

The pick-up request is a request to pick up a package. The pick-up request is transmitted to the server device 200 when the date and time at which the user wants the package to be picked up is determined after the delivery request is received. In the present embodiment, the above-mentioned three types of delivery requests (1) to (3) and the pick-up request (4) are collectively referred to as “delivery request.”

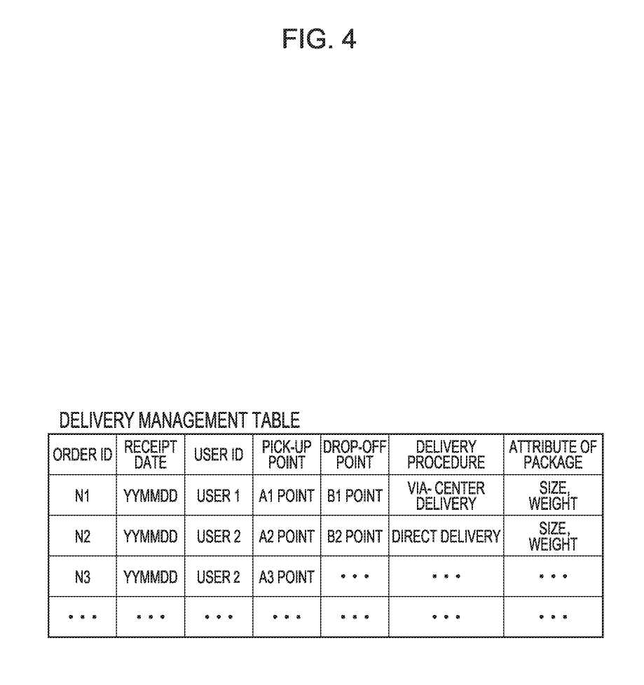

FIG. 4 illustrates an example of a configuration of a delivery management table storing the delivery management information. As shown in FIG. 4, the delivery management table includes columns of an order ID, an order-receipt date, a user ID, a pick-up point, a drop-off point, a delivery procedure, and an attribute of the package.

The order ID is information, for uniquely identifying the delivery request received by the procedure determination unit 2020. The receipt date is the date on which the delivery request was received. The user ID is information for uniquely identifying the user who has transmitted a delivery request to the procedure determination unit 2020. The pick-up point is an address of a place where the package is to be picked up. The drop-off point is an address of a place where the package is to be dropped off, However, the pick-up point and the drop-of point include latitudes and longitudes.

The delivery procedure is a procedure for delivering a package. In the present embodiment, “via-center delivery request” or “direct delivery” is designated. “Via-center delivery request” defines that a package will be delivered via a collection and delivery base. “Direct delivery” defines that a package will be delivered directly from a pick-up point to a drop-off point without passing through a collection and delivery base. When “direct delivery” is designated as delivery management information, a single autonomous vehicle 100 transports a package from the pick-up point to the drop-off point. Therefore, a delivery in which “direct delivery” is designated as the delivery management information is an example of a first delivery procedure, When “via-center delivery request” is designated as the delivery management information, the package is transshipped between a plurality of autonomous vehicles 100 at a collection and delivery base or the like while the package is transported from a pick-up point to a drop-off point, In other words, the package is transshipped between a plurality of mobile objects, that is, a plurality of autonomous vehicles 100 while being transported from the pick-up point to the drop-off point. Therefore, the delivery in which “via-center delivery request” is designated as the delivery management information is an example of a second delivery procedure.

As described above, “via-center delivery request” or “direct delivery” may be designated by, the GUI of the user device 300. However, for a delivery request that is not designated as either “via-center delivery request” or “direct delivery,” the procedure determination unit 2020 of the server device 200 determines whether the delivery procedure is a via-center delivery request or a direct delivery. The attribute of a package includes information on the size and weight thereof, whether the package is fragile, whether the package contains precision machinery, whether the package needs to be refrigerated, and the like. The attribute of the package may be, for example, a pointer indicating entries of an attribute table having such attribute values. In addition, the attribute of the package may be a list in which such attribute values are specified by key values. As described above, the procedure determination unit 2020 is an example of means configured to select either the first delivery procedure or the second delivery procedure.

The delivery request may be issued by, for example, an administrator of the system or a courier. Further, the pick-up request may be acquired from the user via a network or the like. Also, the administrator of the system or the courier may issue a pick-up request. In the following description, a subject who issues the delivery request including the pick-up request is collectively referred to as a user.

The operation command generation unit 2022 determines an autonomous vehicle 100 to be dispatched. In addition, the operation command generation unit 2022 generates an operation command from each record of the delivery management information that is generated by the procedure determination unit 2020 and stored in the delivery management table, and assigns the generated operation command to the autonomous vehicle 100 to be dispatched. Basically, one pick-up operation command and one or more delivery operation commands are generated from one record of the delivery management information. In addition, the operation command generation unit 2022 transmits the generated operation command to the autonomous vehicle 100 and instructs transportation. Therefore, the procedure determination unit 2020 and the operation command generation unit 2022 may be an example of a management unit configured to instruct the autonomous vehicle 100 to deliver the package.

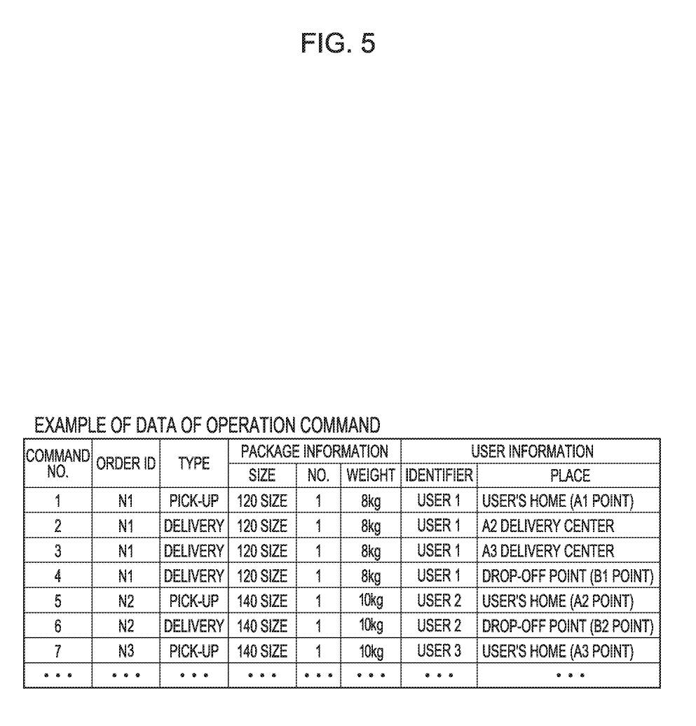

FIG. 5 shows an example of an operation command generated based on the delivery management information as shown in FIG. 4. The operation command includes a command number, an order ID, a type (whether the operation command is for delivery or pick-up), package information, and user information. The command number is information, such as a serial number, for identifying the operation command. The order ID is an order number of the delivery management information stored in the delivery management table,

The package information indicates the number, size, and weight of the package to be delivered. Further, the package information is not limited to the illustrated format as long as it is possible to determine based on the package information whether or not the package can be loaded onto the autonomous vehicle 100. Also, the user information includes information for identifying the user and information on a drop-off point or a pick-up point for the package.

In the example of FIG. 5, the delivery management information having an order ID of N1 is converted to operation commands Nos. 1 to 4. In other words, the delivery management information having an order ID of NI indicates a delivery responding to a delivery request of which the pick-up point is A1 and the drop-off point is B1. In addition, “via-center delivery request” of the delivery procedure is set through designation by the user or the procedure determination unit 2020. For this delivery, the operation command is generated such that the package is picked up and then is delivered to drop-off point B1 via delivery centers A2 and A3 that are collection and delivery bases. On the other hand, the delivery management information having an order ID of N2 indicates a delivery responding to a delivery request of which the pick-up point is A2 and the drop-off point is B2. In addition, “direct delivery” of the delivery procedure is set through designation by the user or the procedure determination unit 2020. The delivery management information having an order ID of N2 is converted to operation commands Nos. 5 and 6. The operation command having command No. 5 is a command to pick up the package at A2 and the operation command having command No. 6 is a command to deliver the package to B2.

The autonomous vehicle 100 to which the operation command is transmitted is determined, for example, according to the position information and the vehicle information (information on whether the vehicle is available for delivery or pick-up) of each vehicle, which are acquired by the vehicle information management unit 2021. In addition, when the request is a pick-up request, the server device 200 may immediately transmit an operation command to the autonomous vehicle 100 to move toward the pick-up point. Further, in order to receive a plurality of pick-up requests, the server device 200 may transmit an operation command to the autonomous vehicle 100 to stand by for a designated period of time.

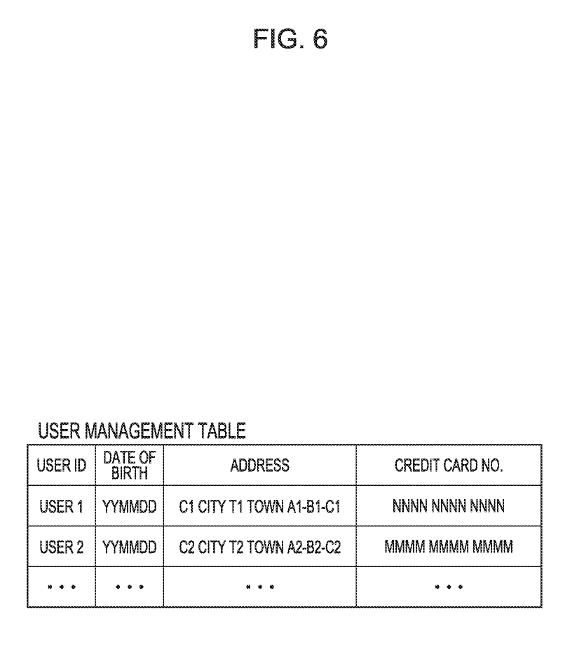

The storage unit 203 stores information and includes a storage medium, such as random access memory (RANI), a magnetic disk, or flash memory. FIGS. 6 to 8 illustrate other examples of a configuration of the table stored in the storage unit 203.

FIG. 6 illustrates an example of a configuration of a user management table. The record of the user management table is generated when the user signs up for the pick-up and delivery system according to the present disclosure. The user management table includes columns of a user ID, date of birth, address, and credit card number. The user ID is information for uniquely identifying the user in the pick-up and delivery system according to the present disclosure. The date of birth and address are the user's date of birth and address, respectively. The credit card number is the number of a credit card owned by the user and is used for paying the delivery fee.

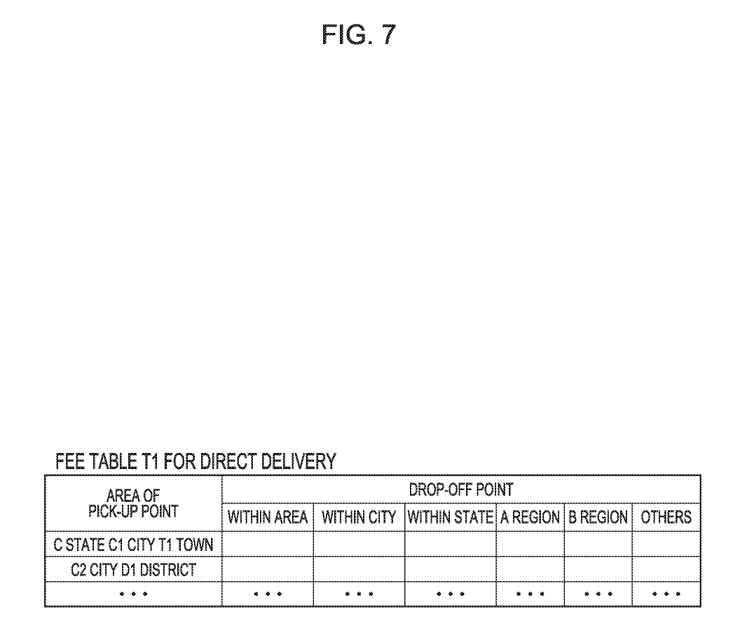

FIG. 7 illustrates an example of a configuration of direct-delivery fee table T1. Fee table T1 for the direct delivery is a table for determining the fee based on the relationship between the pick-up point and the drop-off point. Each record in fee table T1 for the direct delivery specifies a fee for the direct delivery based on the relationship between an area, including the pick-up point and an area including the drop-off point. The area including the pick-up, point is set as an area defined according to addresses such as a state, a city, and a town. The area including the pick-up point is appropriately set so that the size of the area, the longest distance within the area, the population of the area, etc. have predetermined numerical values. The drop-off points are classified into, fix example, “within area,” “within city,” “within state,” “region A,” “region B” and “others.” In each field corresponding to the drop-off point of each record of fee table T1, a fee for a direct delivery from the area of the pick-up point to the drop-off point is set. “Within area” indicates the delivery within the “area of the pick-up point.” “Within city” and “within state” indicate the delivery within an administrative area that is designated as “city” and “state” in the address of the pick-up point. “A region” and “B region” indicate a delivery having ,a drop-off point within a domestic region larger than “city” or “state.” More specifically, when C state belongs to the Kanto district (place name of Japan), “A region” is exemplified by “Hokkaido” and “Tohoku district,” or the like. Further, in FIG. 7, when “the area of the pick-up point” is specified by city, “within area” and “within city” of the drop-off point have the same meaning.

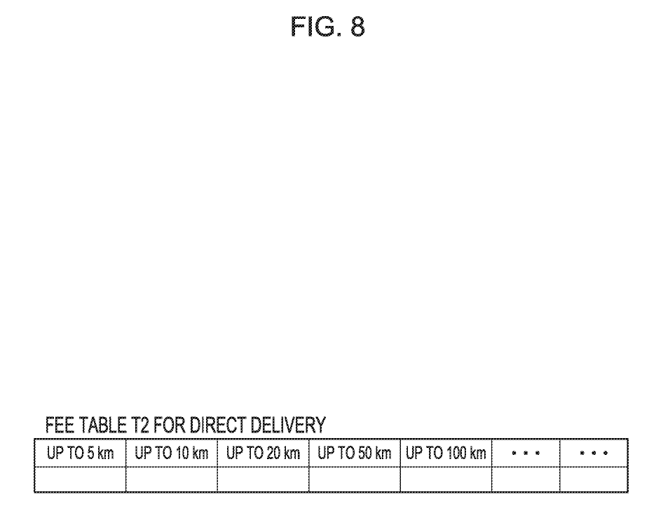

FIG. 8 illustrates an example of a configuration of fee table T2 for the direct delivery. Fee table T2 fix the direct delivery is a table for determining a fee for the direct delivery depending on distance. In this example, the fee is set for each distance range, for example, up to 5 km, up to 10 km, up to 20 km, up to 50 km, and up to 100 km. In addition, as a fee for the via-center delivery request is the same as a fee for an ordinary courier service, the fee table has been omitted.

The user device 300 is, for example, a mobile phone, a smartphone, or a personal computer. The user device 300 includes a communication unit 301, a control unit 302, and a storage unit 303. Since the communication unit 301 and t le storage unit 303 of the user device 300 are similar to the communication unit 201 and the storage unit 203 of the server device 200, respectively, the descriptions thereof have been omitted.

The control unit 302 includes, for example, a CPU and executes, for example, an application program (hereinafter referred to as application 3021) installed in the storage unit 303. The application 3021 is, for example, an application program for accessing the pick-up and delivery system, which is transmitted from a web browser or the server device 200. The application 3021 may include a GUI. In addition, the application 3021 receives a request for the pick-up and delivery system, for example, a delivery request, from the user and transmits the user's request to the server device 200 via the network.

Referring to FIG. 2, the autonomous vehicle 100, the server device 200, and the user device 300 are connected to the same network. However, the network connecting the autonomous vehicle 100 and the server device 200 may be different from the network connecting the server device 200 and the user device 300.

### Hardware Configuration

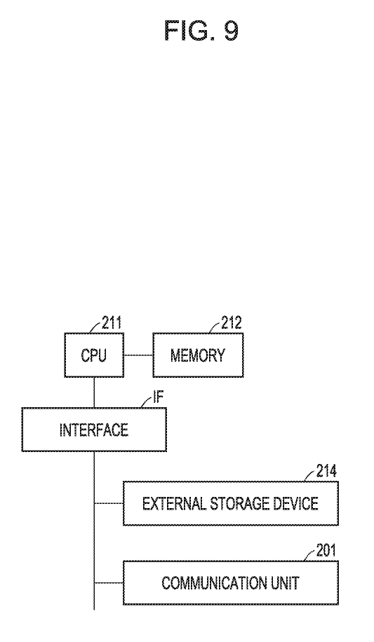

FIG. 9 illustrates a hardware configuration of the server device 200. The server device 200 includes a CPU 211, a memory 212, an interface IF, an external storage apparatus 214, and a communication unit 201. The CPU 211 is an example of the control unit 202 as shown in FIG. 2. The CPU 211 executes a computer program that is deployed in an executable manner in the memory 212, and executes processes as the server device 200. For example, the CPU 211 executes a web server program that provides information to a web browser on the user device 300 according to the HTTP. Through the web server program, the server device 200 provides a GUI on the user device 300, presents information to the user, and receives a user's input and the like.

The memory 212 is an example of the storage unit 203 as shown in FIG. 2. The memory 212 stores. for example, a computer program executed by the CPU 211, and data processed by the CPU 211. The memory 212 is, for example, dynamic random access memory (DRAM), static random access memory (SRAM), or read only memory (ROM). The external storage apparatus 214 is a non-volatile storage apparatus, for example, a solid state drive (SSD) or a hard disk drive.

In addition, the external storage apparatus 214 may be a recording medium readable by a computer or other machines and devices (hereinafter referred to as “computer or the like”) including the server device 200. Further, a program causing the computer or the like to implement any functions of the present embodiment may be recorded in the external storage apparatus 214. In addition, such functions of the present embodiment may be provided by causing the computer or the like to read and execute the program of the recording medium.

Herein, the recording medium readable by the computer or the like is a recording medium in which information such as data and programs, is accumulated by an electrical, magnetic, optical, mechanical or chemical action and from which the information can be read by, the computer or the like. Examples of the recording medium detachable from the computer or the like includes a flexible disk, a magneto-optical disk, a CD-ROM, CD-R/W, a digital video disk (DVD), a Blu-ray disk, a digital audio tape recorder (DAT), 8 mm tape, and a memory card of a flash memory. Examples of the recording medium fixed to the computer or the like includes a hard disk, a read only memory (ROM), or the like. Further, an SSD may be used as a recording medium detachable from the computer or the like, or as a recording medium fixed to the computer or the like.

The communication unit 201 is identical to the communication unit 201 as shown in FIG. 2 and includes, for example, a network interface card (NIC) and a local area network (LAN) card. The communication unit 201 is connected to a public network such as the Internet via a wired communication network or a wireless communication network. Although it is not shown in FIG. 9, the server device 200 may include, fir example, a keyboard, a pointing device such as a mouse, and a touch panel, as an input unit configured to receive operations of the administrative user of the pick-up and delivery system. In addition, the server device 200 may include a display and a speaker as an output unit configured to provide information to the administrative user.

### Operation

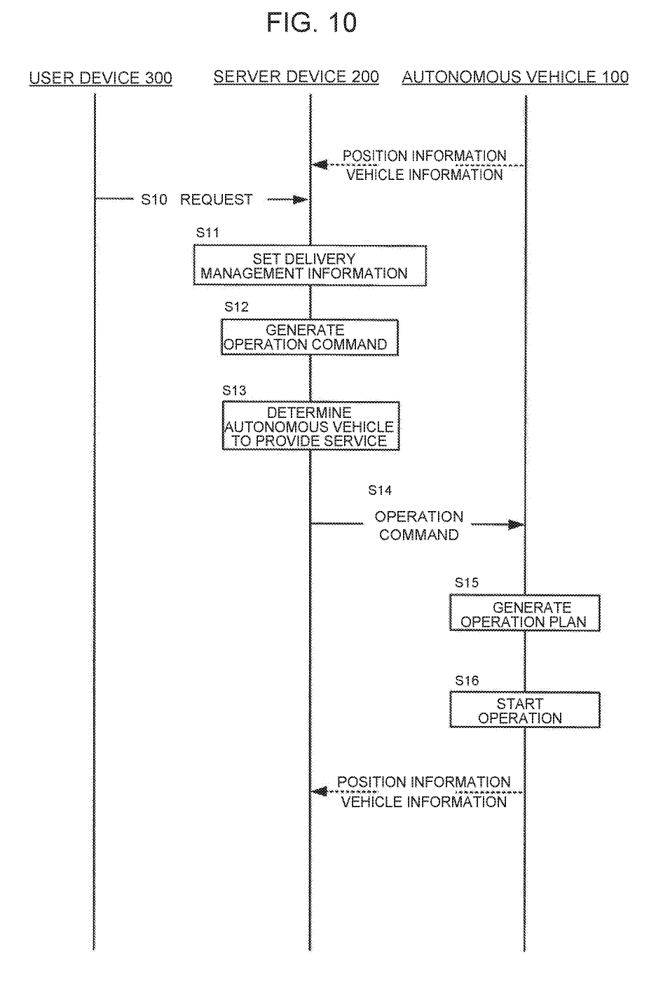

The process performed by each of the above-described components will be described below. FIG. 10 illustrates a data flow of the processes starting from when the server device 200 generates the delivery management information and the operation command based on the delivery request acquired from the user until the autonomous vehicle 100 starts operating.

The autonomous vehicle 100 periodically notifies the server device 200 of position information. For example, when a road network is defined by nodes and links, the position information may specify such nodes or links. In addition, the position information may be coordinates such as latitude or longitude. The vehicle information management unit 2021 stores, in the storage unit 203, the notified position information associated with the autonomous vehicle 100. Whenever the autonomous vehicle 100 travels, the position, information is updated.

In addition, the autonomous vehicle 100 periodically notifies the server device 200 of the vehicle information. In the present embodiment, the autonomous vehicle 100 transmits the following information as vehicle information. Moreover, among the information listed below, information unique to the autonomous vehicle 100 does not need to be repeatedly transmitted. The information includes: the capacity of the vehicle (for example, a loadable size, weight, and number of packages); the number of currently loaded packages; volume of currently loaded packages; weight of currently loaded packages; current remaining battery power, i.e., state of charge (SOC); a travelable distance, information on an operation route of the vehicle in operation; information on packages to be further loaded on the route (for example, the number, volume, and weight of packages, and pick-up points); and information on packages to be unloaded on the route (for example, number, volume, and weight of packages, and drop-off points).

When the user transmits a request (a delivery request or a pick-up request) to the server device 200 via the user device 300 (step S10), the server device 200 (the procedure determination unit 2020) receives the request, generates delivery management information, and stores the delivery management information in the delivery management table (step S11). Then, the server device 200 (the operation command generation unit 2022) generates an operation command based on the delivery management information (step S12). The procedure determination unit 2020 of the server device 200 executes steps S11 and S12 as an example of a receiving unit that receives a delivery request including a pick-up point for a package (i.e., a location where a package is picked up) and a drop-off point for the package (i.e., a location where the package is dropped off).

In step S13, the operation command generation unit 2022 selects the autonomous vehicle 100 to provide a service. For example, the operation command generation unit 2022 refers to the stored position information and the stored vehicle information on the autonomous vehicle 100, and determines which autonomous vehicle 100 is capable of providing the requested service. In step S14, the operation command is transmitted from the server device 200 to a corresponding autonomous vehicle 100.

In step S15, the autonomous vehicle 100 (the operation plan generation unit 1031) generates an operation plan, based on the received operation command. For example, the autonomous vehicle 100 generates an operation plan for returning to a designated place (for example, a delivery center) when there is no remaining operation command after picking up and delivering the packages by specifying a route for traveling, a point where the package is to be handed over on the route, and a point where the package is to be received on the route.

The generated operation plan is transmitted to the task control unit 1033, and the operation is started (step S16). Further, during the operation, the position information and the vehicle information are periodically transmitted to the server device 200.

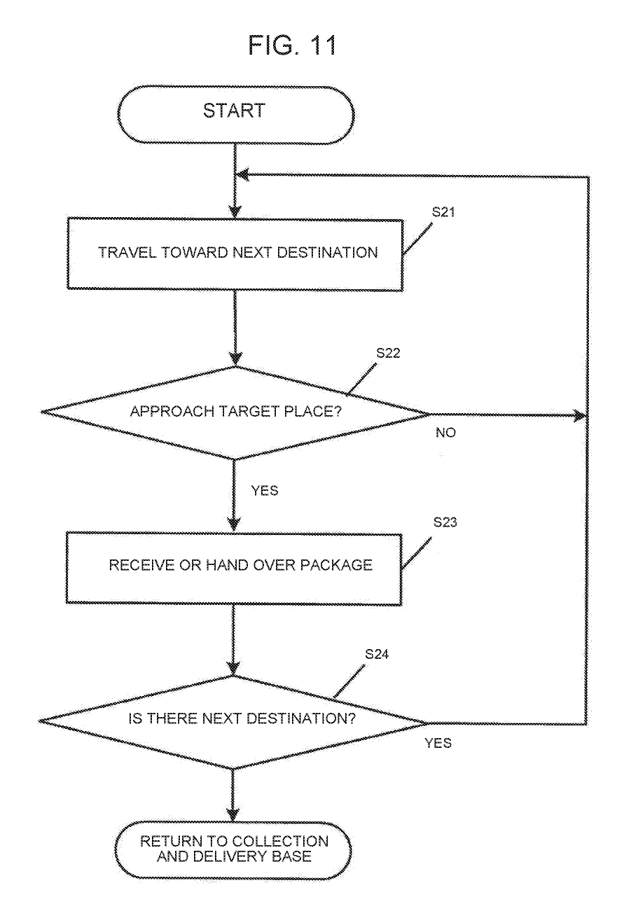

FIG. 11 is a flowchart of a process performed by the autonomous vehicle 100 after the operation is started in step S16. First, in step S21, the task control unit 1033 initiates the travel of alae autonomous vehicle 100 toward the next destination (a drop-off point or a pick-up point) based on the generated operation plan. When the autonomous vehicle 100 approaches a target place (step S22), the task control unit 1033 searches for a place where the autonomous vehicle 100 can come to a stop in the vicinity, and controls the autonomous vehicle 100 such that the autonomous vehicle 100 stops and receives or hands over the package (step S23). The task control unit 1033 may transmit a message to a user device 300 such as a portable terminal carried by a recipient user and call the user to receive the package. In addition, when a delivery locker or the like is provided, the package can be received automatically (for example, by using the technique described in JP 6164599 B). Further, the autonomous vehicle 100 may further carry a small autonomous mobile object and cause the small autonomous mobile object to transport the package. In addition, the task control unit 1033 asks for an input of receipt certificate information which was previously sent from the server device 200 to the recipient user (that is, to the user device 300 used by the recipient user), and when the receipt certificate information is input and authentication is successful, the package may be handed over. When the authentication is successful by the input of the receipt certificate information, the task control unit 1033 may control the autonomous vehicle 100 such that the autonomous vehicle 100 opens the door and hands over the package to the recipient user. Then, the task control unit 1033 may ask the user to confirm the receipt thereof, and when the user inputs the receipt confirmation, the delivery is completed.

Next, the task control unit 1033 determines whether there is a next destination (a drop-off point or a pick-up point) based on the operation plan (step S24). When there is a next destination, the task control unit 1033 controls the autonomous vehicle 100 such that the autonomous vehicle 100 continuously performs the operation. On the other hand, when there is no next destination, the task control unit 1033 controls the autonomous vehicle 100 such that the autonomous vehicle 100 returns to the collection and delivery base.

### Generating Delivery Management Information

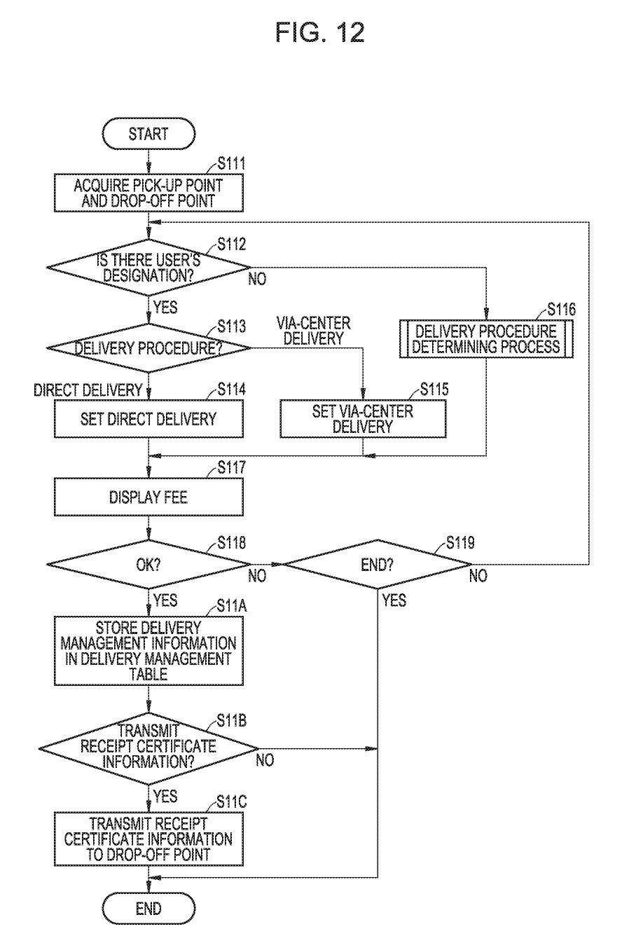

FIG. 12 illustrates a process of generating, delivery management information to be executed by the procedure determination unit 2020. In this process, the procedure determination unit 2020 of the server device 200 acquires a pick-up point and a drop-off point from, for example, a GUI (step S111). Then, the procedure determination unit 2020 determines whether or not the user has designated the delivery procedure (step S112). When the user has designated the delivery procedure, the procedure determination unit 2020 determines whether the user has designated “direct delivery” or “via-center delivery request” (step S113).

When the user has designated “direct delivery,” the procedure determination unit 2020 sets the direct delivery in the delivery management information (step S114). On the other hand, when the user has designated “via-center delivery request,” the procedure determination unit 2020 sets the via-center delivery request in the delivery management information (step S115). When the procedure determination unit 2020 determines that the user has designated no delivery procedure in step S112, the procedure determination unit 2020 executes a delivery procedure determining process (step S116). In the delivery procedure determining process, the procedure determination unit 2020 determines, whether the delivery should be made by direct delivery or via-center delivery request based on the relationship between the pick-up point and the drop-off point. The procedure determination unit 2020 prioritizes the determination in S112 over the delivery procedure determining process in S116 such that the procedure determination unit 2020 selects the first delivery procedure of direct delivery or the second delivery procedure of via-center delivery request by prioritizing the user's selection. In this case, the designation by the user may be the designation by the user of the pick-up point.

The procedure determination unit 2020 displays the fee corresponding to the selected delivery procedure (step S117). For example, when the direct delivery is to be made, the procedure determination unit 2020 refers to fee table TI'for the direct delivery (see FIG. 7), determines the fee, and displays the fee on the GUI. However, the procedure determination unit 2020 may determine the fee with reference to fee table T2 for the direct delivery (see FIG. 8).

Then, the procedure determination unit 2020 asks the user to confirm the fee. When the user inputs “OK” in step S118, the procedure determination unit 2020 stores the input to the GUI and the delivery management information generated in steps S111 to S116 in the delivery management table (step S11). Also, the procedure determination unit 2020 asks the user to confirm whether the receipt certificate information should be transmitted to the recipient user in advance (step S11B). By transmitting the receipt certificate information to the recipient user, when the autonomous vehicle 100 delivers the package to the recipient user, the autonomous vehicle 100 can authenticate the recipient user by using the receipt certificate information. When it is determined that the receipt certificate information should be transmitted to the recipient user in advance, the procedure determination unit 2020 transmits the receipt certificate information to the recipient user in advance (step S11C). For example, a password, a QR code (registered trademark), a random character string, and key information according to digital data may be used as the receipt certificate information.

On the other hand, if the user does not input “OK” in step 8118, the procedure determination unit 2020 asks the user to confirm whether to end the process (step S119). If the user does not want to end the process, the procedure determination unit 2020 returns the process to S112 and, receives the, user's designation again. On the other hand, when the user wants to end the process, the procedure determination unit 2020 ends the process.

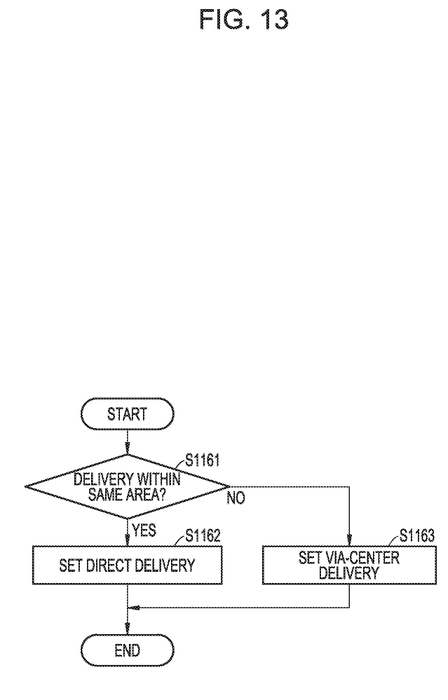

FIG. 13 illustrates details of the delivery procedure determining process (step S116 in FIG. 12). In this process, the procedure determination unit 2020 determines whether the delivery is within the same area based on the relationship between the pick-up point and the drop-off point (step S1161). If the delivery is made within the same area, the procedure determination unit 2020 sets the direct delivery in the delivery management information (step S1162). On the other hand, if the delivery is not made within the same area, the procedure determination unit 2020 sets the delivery to via-center delivery request in the delivery management information (step S1163).

The determination conditions in steps S112 and S113 in FIG. 12 and in step S1161 in FIG. 13 are examples of predetermined determination conditions, Further, the determinations in steps S112 and S113 and the delivery procedure determining process in step S116, which are made by the procedure determination unit 2020, may be examples of selecting one of the first delivery procedure and the second delivery procedure depending on whether the pick-up point and the drop-off point satisfy a predetermined condition, Further, the determination in step S1161 may be an example of determining whether information on an area which is included in the addresses of the pick-up point overlaps with information on an area which is included in the address of the drop-off point.

### Modification

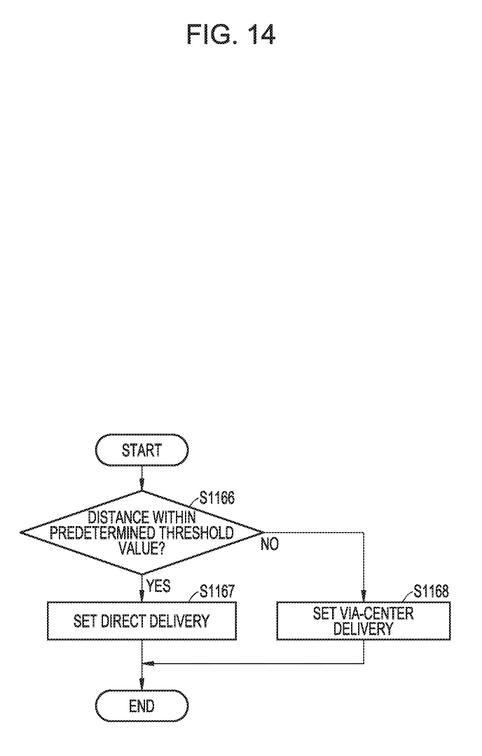

FIG. 14 illustrates a modification of details of the delivery procedure determining process (step S116 in FIG. 12). In this process, the procedure determination unit 2020 determines whether the delivery distance is within a predetermined threshold value, based on the relationship between the pick-up point and the drop-off point (step S1166). When the delivery distance is within the predetermined threshold value, the procedure determination unit 2020 sets the delivery to direct delivery in the delivery management information (step S1167). On the other hand, when the delivery distance is not within the predetermined threshold value, the procedure determination unit 2020 sets the delivery to via-center delivery request in the delivery management information (step S1168). The determination condition in step S1166 may be an example of a condition in which the pick-up point and the drop-off point are within a predetermined distance range.

### Advantageous Effect of Embodiment

AS described above, the server device 200 according to the present embodiment determines whether the delivery is made by the via-center delivery request or the direct delivery in response to a user's delivery request, generates an operation command, and issues the command to the autonomous vehicle 100. Therefore, the server device 200 can adopt an appropriate delivery procedure for each delivery request to deliver a package by using the autonomous vehicle 100.

In addition, the server device 200 selects one of the via-center delivery request and the direct delivery for the delivery procedure based on the relationship between the pick-up point and the drop-off point designated in the delivery request. Therefore, the server device 200 can appropriately select the delivery procedure based on the relationship between the pick-up point and the drop-off point

In addition, the server device 200 selects the direct delivery when the areas which is included in the addresses of the pick-up point and the drop-off point, which are designated in the delivery request, are overlapping, so that the delivery time for the delivery within the same area can be shortened. Further, the server device 200 selects the direct delivery when the distance between the pick-up point and the drop-off point designated in the delivery request is within a predetermined threshold value, so that the delivery time for a short-distance delivery can be shortened.

In addition, the server device 200 selects the via-center delivery request or the direct delivery by prioritizing the delivery procedure designated by the user through the GUI of the user device 300. Therefore, the server device 200 can select the delivery procedure that matches the user's intention. In addition, the server device 200 presents the delivery fee corresponding to the delivery procedure and asks the user to confirm the delivery fee. Therefore, the user can determine whether to prioritize the delivery time or the delivery fee.

In addition, when the user does not designate the delivery procedure on the GUI of the user device 300, the server device 900 selects the via-center delivery request or the direct delivery based on the relationship between the pick-up point and the drop-off point. Therefore, the delivery procedure can be determined in consideration of delivery efficiency of the pick-up and delivery system.

In the above embodiment, the autonomous vehicle 100 asks for an input of the receipt certificate information which is transmitted in advance to the recipient user from the server device 200, and when authentication is successful due to the input of the receipt certificate information, the package can be handed over. Therefore, the autonomous vehicle 100 can safely deliver the package.

### Other Embodiments

In the above embodiment, the server device 200 sends an operation command to the autonomous vehicle 100 and instructs the autonomous vehicle 100 to deliver a package. However, the process according to the above embodiment is not necessarily performed by the pick-up and delivery system using the autonomous vehicle 100. For example, the server device 200 selects the via-center delivery request or the direct delivery and commands the operation in conventional delivery services by sending an operation command to a mobile phone, an in-vehicle device, or the like possessed by a driver of a courier service, In other words, by adopting the server device 200 according to the above embodiment, the courier can select and provide the via-center delivery request or the direct delivery. In this case, as in the above embodiment, the server device 200 prioritizes the user's designation. When the user does Trot designate a delivery procedure, the server device 200 can select one of the via-center delivery request and the direct delivery based on the relationship between the pick-up point and the drop-off point. The user may select the via-center delivery request or the direct delivery in consideration of the delivery fee and the delivery time.

Further, in the pick-up and delivery system according to the present embodiment, the autonomous vehicle 100 is used as a transporting unit. However, the transporting unit of the present delivery system is not limited to the autonomous vehicle 100. For example, an ordinary vehicle, a two-wheeled vehicle, a ship or an aerial object such as a drone may be used instead of the autonomous vehicle 100.

Further, in the above embodiment, the operation plan generation unit 1031 of the autonomous vehicle 100 acquires the operation command from the server device 200 and generates the operation plan for the corresponding vehicle. However, the server device 200 may include the same configuration as that of the operation plan generation unit 1031 to generate the operation plan. Further, the server device 200 may communicate with the autonomous vehicle 100 at every moment and transmit the operation plan. The autonomous vehicle 100 may transmit the implementation status of the operation plan to the server device 200 at a predetermined time.

What is claimed is:

1. An information processing apparatus comprising:
a receiving unit configured to receive a delivery request including a pick-up point and a drop-off point for a package; and
a managing unit configured to select one of a first delivery procedure for transporting the package from the pick-up point to the drop-off point by using a single mobile object and a second delivery procedure for transporting the package from the pick-up point to the drop-off point by transshipping the package between a plurality of mobile objects, and to instruct a control unit configured to control transportation via the mobile object such that the package is delivered in accordance with the selected delivery procedure.

2. The information processing apparatus according to claim 1, wherein the managing unit, is configured to select one of the first delivery procedure and the second delivery procedure depending on whether the pick-up point and the drop-off point satisfy a predetermined condition.

3. The information processing apparatus according to claim 2, wherein the predetermined condition is a condition that information on an area which is included in an address of the pick-up point overlaps with information on an area which is included in an address of the drop-off point, or a condition that the pick-up point and drop-off point are located within a predetermined distance,

4. The information processing apparatus according to claim 1, wherein the managing unit is configured to receive a user's selection for the delivery procedure from a user at a delivery request point and select the first delivery procedure or the second delivery procedure by prioritizing, the user's selection.

5. A pick-up and delivery system comprising:
a plurality of mobile objects; and
an information processing apparatus,
wherein the information processing apparatus includes:
a receiving unit configured to receive a delivery request including a pick-up point and a drop-off point for a package; and
a managing unit configured to select one of a first delivery procedure for transporting the package from the pick-up point to the drop-off point by using a single mobile object and a second delivery procedure for transporting the package from the pick-up point to the drop-off point by transshipping the package between the plurality of mobile objects, and to instruct a control unit configured to control transportation via the mobile object such that the package is delivered in accordance with the selected delivery procedure.

6. A pick-up and delivery method comprising:
receiving, by a computer, a delivery request including a pick-up point and a drop-off point for a package; and
selecting, by the computer, one of a first delivery procedure liar transporting the package from the pick-up point to the drop-off point by using a single mobile object and a second delivery procedure for transporting the package from the pick-up point to the drop-off point by transshipping the package between a plurality of mobile objects, and instructing a control unit configured to control transportation via the mobile object such that the package is delivered in accordance with the selected delivery procedure.

7. The pick-up and delivery method according to claim 6, wherein the computer selects one of the first delivery procedure and the second delivery procedure depending on whether the pick-up point and the drop-off point satisfy a predetermined condition.

8. The pick-up and delivery method according to claim 7, wherein the predetermined condition is a condition that information on an area which is included in an address of the pick-up point overlaps with information on an area which is included in an address of the drop-off point, or a condition that the pick-up point and drop-off point are located within a predetermined distance.

9. The pick-up and delivery method according to claim 6, further comprising receiving, by the computer, a user's selection for the delivery procedure from a user who requests a delivery before selecting one of the first delivery procedure and the second delivery procedure, wherein the computer selects the first delivery procedure or the second delivery procedure by prioritizing the user's selection.

10. A non-transitory computer readable recording medium with a program recorded thereon, wherein the program comprises commands for causing a computer:
to receive a delivery request including a pick-up point and a drop-off point for a package; and
to select one of a first delivery procedure for transporting the package from the pick-up point to the drop-off point by using a single mobile object and a second delivery procedure for transporting the package from the pick-up point to the drop-off point by transshipping the package between a plurality of mobile objects and to instruct a control unit configured to control transportation via the mobile object such that the package is delivered in accordance with the selected delivery procedure.
